(19) United States
(12) Patent Application Publication
(10) Pub. No.: US 2020/0293032 A1
(43) Pub. Date: Sep. 17, 2020

(54) EXTREMELY FAST SUBSTATION ASSET MONITORING SYSTEM AND METHOD

(71) Applicant: GENERAL ELECTRIC COMPANY, Schenectady, NY (US)

(72) Inventors: Honggang Wang, Clifton Park, NY (US); Weizhong Yan, Clifton Park, NY (US); Lijun He, Schenectady, NY (US); Liwei Hao, Niskayuna, NY (US)

(21) Appl. No.: 16/562,570

(22) Filed: Sep. 6, 2019

Related U.S. Application Data
(60) Provisional application No. 62/817,956, filed on Mar. 13, 2019.

(51) Int. Cl. G05B 23/02; G06N 20/00; G06N 5/04; H02J 13/00

(52) U.S. Cl. CPC G05B 23/027; H02J 13/00; G06N 5/04; G06N 20/00

(57) ABSTRACT

embodiments are directed to a system, method, and article for monitoring a power substation asset. During an offline analysis mode, training data may be acquired and processing, and one or more classifiers may be generated for an online anomaly detection and localization mode. During the online anomaly detection and localization mode, power system related data may be received from field devices, a state of a substation system and of the power substation asset component and an unclassified state of one or instances may be generated based on the one or more classifiers. An alert may be generated to indicate the state of the substation system and of the power substation asset.

### CROSS-REFERENCE TO RELATED APPLICATIONS

The present application claims the benefit of U.S. Provisional Patent Application No. 62/817,956 entitled “EXTREMELY FAST SUBSTATION ASSET MONITORING” and filed on Mar. 13, 2019. The entire content of that application is incorporated herein by reference.

### BACKGROUND

A power grid or electrical grid is an interconnected network for delivering electricity from producers to consumers. A power grid typically contains various pieces of equipment or assets. For example, a power system may include one or more generators, one or more substations, power transmission lines, and power distribution lines. A generator or generating station may generate electric power from sources of primary energy or may convert motive power into electrical power for transmission to a power electrical grid. A substation may be a part of an electrical generation, transmission, and distribution system. Between a generating station and consumer, electric power may flow through several substations at different voltage levels. A substation may include transformers to change voltage levels between high transmission voltages and lower distribution voltages, or at the interconnection of two different transmission voltages. Electric power transmission lines may facilitate bulk movement of electrical energy from a generating site, such as a power plant comprising one or more generators, to one or more electrical substations. The interconnected lines which facilitate this movement are known as a transmission network.

Substations typically contain or are otherwise dependent upon a number of critical assets. These assets include items such as power transformers, Current transformers, Potential transformers, circuit breakers, protective relays, insulators, Intelligent Electronic Devices (LEDs), Lightening arresters, capacitor banks, and underground cables, to name just a few examples among many. The aging infrastructure spread across large territories becomes a challenge for the grid reliability and power availability.

Existing substation monitoring processes may take multiple seconds or minutes to be performed. In a traditional anomaly and fault diagnosis system, detection and localization typically occurs in serial, thereby imposing delays in the localization. Electric power systems, however, exhibit very fast dynamics which may require attack detection and localization to also occur relatively quickly.

Studies show that approximately 50% of customer-minutes lost may be attributed to equipment failure. Installation of a sensor such as Dissolved Gas Analysis (DGA) and/or Partial Discharge (PD) may introduce additional costs and complexity to a system, as well as new reliability challenge. Phasor Measurement Unit (PMU) data of one or more assets of a substation, such as measured at 30˜120 sample/sec, Global Positioning System (GPS) synchronized, and/or phasor have not fully explored or currently used for asset monitoring. For equipment failure, PMU-captured data for a substation is currently primarily analyzed in a post-event fashion, using an engineer's judgment.

Critical assets such as power transformers may be monitored online with additional instruments, such as dissolved gas analysis (DGA) sensors, partial discharge (PD) monitor sensors, moisture sensors at various locations of the equipment like main oil tank, on-load tap changer (OLTC), and bushing. However, the installation of additional sensors adds extra cost and complexity to the system, as well as new reliability challenge, for example DGA sensors need replacement every 5-10 years. For uncritical assets there is less/no sensor installed that can help with online monitoring the asset healthy condition. Instead, onsite field inspection is always required, and unplanned maintenance may cause unnecessary downtime and extra repair cost.

### SUMMARY

According to an aspect of an example embodiment, a method may include monitoring a power substation asset. During an offline analysis mode, training data may be acquired and processing, and one or more classifiers may be generated for an online anomaly detection and localization mode. During the online anomaly detection and localization mode, power system related data may be received from field devices, a state of a substation system and of the power substation asset component and an unclassified state of one or instances may be generated based on the one or more classifiers. An alert may be generated to indicate the state of the substation system and of the power substation asset.

According to an aspect of another example embodiment, a system may include a receiver to receive power system related data from field devices and training data. A processor may implement an offline analysis mode and an online anomaly detection and localization mode. During the offline analysis mode training data may be acquired and processing, and one or more classifiers may be generated for an online anomaly detection and localization mode. During the online anomaly detection and localization mode, power system related data may be received from field devices, a state of a substation system and of the power substation asset component and an unclassified state of one or instances may be generated based on the one or more classifiers. The processor may also generate an alert to indicate the state of the substation system and of the power substation asset.

According to an aspect of another example embodiment, an article may comprise a non-transitory storage medium comprising machine-readable instructions executable by one or more processors. The instructions may be executable by the one or more processors to process power system related data received from field devices and training data. The instructions may also be executable to implement an offline analysis mode and an online anomaly detection and localization mode. During the offline analysis mode training data may be acquired and processing, and one or more classifiers may be generated for an online anomaly detection and localization mode. During the online anomaly detection and localization mode, power system related data may be received from field devices, a state of a substation system and of the power substation asset component and an unclassified state of one or instances may be generated based on the one or more classifiers. The instructions may be further executable to generate an alert to indicate the state of the substation system and of the power substation asset.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a power distribution grid.

FIG. 2 is a functional block diagram of an embodiment of an Extremely Fast Substation Monitoring System (EFSMS) according to an embodiment according to an embodiment.

FIG. 3 is a system block diagram of an EFSMS according to an embodiment.

FIG. 4 illustrates an embodiment a system diagram of a EFSMS and corresponding inputs and outputs according to an embodiment.

FIG. 5 illustrates an embodiment of a process for performing asset monitoring of power substation asset monitoring system.

FIG. 6 illustrates an embodiment of a neural network for determining a classifier for an EFSMS.

FIG. 7 illustrates an embodiment of a multi-scale convolutional neural network (MCNN) framework for determining a classifier for an EFSMS.

FIG. 8 illustrates an embodiment of a system architecture diagram of a power management system.

FIG. 9A illustrates a system diagram of an embodiment in which an EFSMS module is disposed separate from a phasor data concentrator (PDC).

FIG. 9B illustrates a system diagram of an embodiment in which an EFSMS module is integrated with a PDC.

FIG. 10A illustrates a system diagram of an embodiment for a hierarchical configuration of an EFSMS.

FIG. 10B illustrates a system diagram of an embodiment for a modular and decentralized configuration of an EFSMS.

FIG. 11 illustrates a power grid system including an EFSMS module in accordance with an example embodiment.

FIG. 12 illustrates an EFSMS server according to an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments, as discussed herein, generally comprise a power grid and substation monitoring system. In one aspect, rapid detection and localization may be performed in which detection and localization occur in one shot. For example, substation asset state monitoring may be performed in accordance with an embodiment at a subsecond rate, such that early warning indications may be provided for potentially malfunctioning equipment, and equipment may be proactively replaced and/or repaired before the equipment becomes damage. An electric utility's incidence of forced outage of equipment and capital replacement costs may be reduced, and catastrophic failures and collateral damage may thereby be avoided. In one aspect, a Phasor Measurement Units (PMU) application may be extended to substation asset monitoring, for example.

A “Phasor Measurement Unit” or “PMU,” as used herein, refers to a device used to estimate the magnitude and phase angle of an electrical phasor quantity (such as voltage or current) in a power grid using a common time source for synchronization. Time synchronization may be provided by Global Positioning System (GPS) coordinates and may allow for synchronized real-time measurements of multiple remote points on an electricity grid. PMUs may be capable of capturing samples from a waveform in quick succession and reconstructing a phasor quantity, made up of an angle measurement and a magnitude measurement, for example. A resulting measurement is known as a “synchrophasor.” Such time synchronized measurements may be monitored, for example, because if a power grid's supply and demand are not perfectly matched, frequency imbalances may cause stress on the power grid, potentially resulting in power outages.

PMUs may also be used to measure a frequency in a power grid. A typical commercial PMU may report measurements with very high temporal resolution in the order of 30-60 measurements per second, for example. Such measurements may assist engineers in analyzing dynamic events in the power grid which may not be possible with traditional Supervisory Control and Data Acquisition (SCADA) measurements which generate one measurement every 2 or 4 seconds. PMUs may therefore equip utilities with enhanced monitoring and control capabilities and are considered to be one of important measuring devices in the future of power systems. A system may include one or more receivers or transceivers, for example, to receive signals comprising measurements or parameters from one or more PMUs.

A power substation asset monitoring system in accordance with one or more embodiments, as discussed herein, may comprise an offline analysis module which may acquire training data from different sources. The system may process the training data and generate one or multiple classifiers for an online anomaly detection and localization module. An online anomaly detection and localization module may receive power system-related data from field devices and may generate or determine a state of substation system and component and one or more instances of an unclassified state.

An asset monitoring system in accordance with an embodiment may provide an automatic solution (e.g., a software solution) to correlate PMU captured event data to determine a status of an asset or equipment. PMU data may be analyzed to provide a relatively fast diagnosis (e.g., at a subsecond level) to avoid more severe equipment failure or explosion, for example. A systematic approach is provided in accordance with an embodiment as discussed herein may unleash the power of the big volume of PMU data together with operational and non-operational data, along with the help of advanced artificial intelligence (AI) and/or machine learning (ML) technology for asset monitoring and diagnosis, for example.

An embodiment, as discussed herein, may perform anomaly detection and may also provide anomaly localization to a component level. Moreover, a machine learning-based approach may include intelligence such as a “self-healing” model update, for example. Substation assets may be monitored approximately in real-time with a PMU streaming time series analysis, for example. A one-shot anomaly detection and identification module may, for example, enable relatively fast diagnosis. A collection of ensembles may be combined with data augmentation for enhanced classification accuracy under a small sample size and unbalanced data challenge. An embodiment may provide an automatic model update triggered, for example, by a certified public resource event and/or an operator-acknowledged event with a label.

Relatively few labeled data (such as PMU data) may currently be available because PMU installations have only recently been performed. A traditional deep learning approach may suffer from overfitting or poor generalization performance with a relatively small sample size data and unbalanced data (e.g., a lot of normal data but very few data for a certain anomaly). A data source may be extended from not only a simulator, but also from an equipment failure mode data sheet and publicly available PMU related asset data, for example. Furthermore, a data augmentation approach may be utilized such as Down sampling, Jittering, Scaling, warping, and/or permutation (three phase), to name just a few examples, to enhance the classifier's prediction accuracy and generalization capability. Ensembles of different similarity metrics, time and frequency transformations, and single component and multiple component interaction features may additionally be leveraged to further enhance a classifier's accuracy, for example.

Use of PMU data for substation asset state monitoring is at a relatively early stage and no machine learning model may be capable of handling all possible scenarios or events. A scheme is therefore provided in accordance with one or more embodiments so as to allow a model to automatically update. Automatic updating may be performed by proper design of model output and a model performance monitoring module, for example. First, there may be an “unclassified class” as a classifier model output, which may be true if an incoming subsequent time series does not belong to any of a normal or predefined anomaly class. For each unclassified instance, for example, a counter in a model performance module may increase by a value of “one.” Meanwhile, a time series may be saved in a temporal database. To enable interactive learning from the operator, for example, a model performance module may also issue an alert to a user interface in a control center. Once a number of unclassified instances reach to a certain threshold number, such as 20, for example, the system may trigger a low-level alarm once to allow for an operator to analyze stored time series snapshots and confirm a particular data label. Subsequent labeled data may be sent to a classifier database for model training use. This automatic model update with a learning capability from human may make the system adaptable to system changes caused by reconfiguration, retrofit and/or device replacement, for example.

Another way to update a model is actively search for PMU related asset condition data from publicly available resources, such as from industry literature, event logs, and/or outage reports, etc. Once new available data reaches a certain value, a similarity between a new instances and an existing training instance may be conducted. If the highest similarity index value goes below a predefined threshold, then this new instance may be added to the training instance and a new model can be initiated.

With a proliferation of PMU installations, synchrophasor technology offers unprecedented visibility into what is happening on the grid as a whole, and into what is happening with individual power plants and pieces of grid equipment. Synchrophasor systems may enable better electric system observation and problem diagnosis because synchrophasor technology synchronously samples and records grid conditions with unprecedented speed and granularity. While SCADA systems may sample grid conditions every 2 to 4 seconds, PMUs may measure frequency, voltage phasors, and current phasors at the rate of 30 to 120 samples per second and may calculate real and reactive power values from those phasor measurements. Thus, PMUs may capture dynamic and transient events that are not seen in SCADA monitoring. Every phasor measurement and calculated value is time-synchronized against Universal Time (e.g., within 1 microsecond, as determined using GPS), producing accurate, time-aligned measurements that may be compared and tracked across wide geographic areas. This makes it easier to correctly identify and diagnose events occurring across a large region.

Various assets and related monitoring equipment may generate large volumes operational and non-operational data. Examples of operational data include information such as voltage, current, breaker status, and other information which may be used to monitor and control operation of a substation and other elements of the transmission and distribution system on a substantially real time basis. Example of non-operational data include analytical data (e.g., digital fault records target records, load profiles, power quality, sequence of events, and the like), equipment condition information (e.g., equipment temperature, dissolved gasses, operating and response times, and so on), and temperature, rainfall, and other ambient condition information. Both operational and non-operational data may have relatively substantial value for monitoring and analyzing the operation of a particular asset.

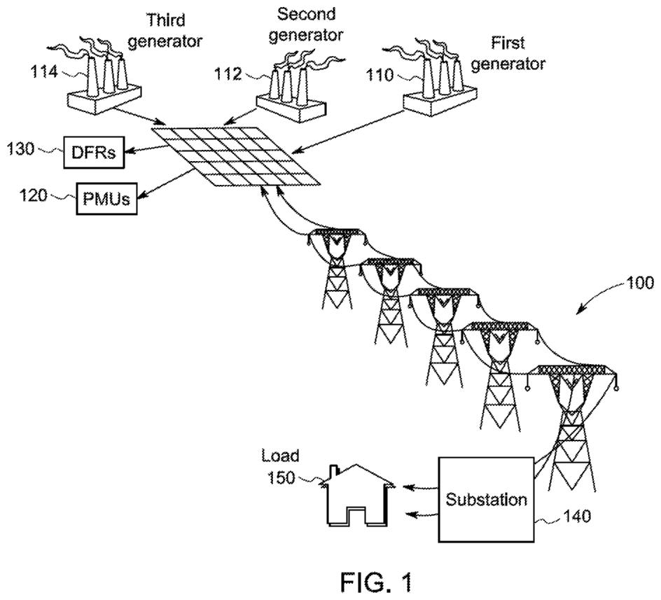

FIG. 1 illustrates an embodiment 100 of a power distribution grid. The grid of embodiment 100 may include a number of components, such as one or more power generators, for example, a first generator 110, second generator 112, and/or third generator 114. Although only three generators are shown in FIG. 1, it should be appreciated that more or fewer than three generators may be utilized in accordance with an embodiment. The grid of embodiment 100 may include transmission networks, transmitting electrons from power generator to one or more substations, such as substation 140, and distribution networks to various loads or users. In embodiment 100, for example, electrons may be transmitted from substation 140 to various loads, such as load 150. Although only a single substation 140 is illustrated in FIG. 1, it should be appreciated that numerous substations may be included in some embodiments, such as where electric power is transmitted from one or more generators to different geographically dispersed loads, for example. Similarly, although only a single load 150 is illustrated in FIG. 1, multiple loads may be included in some embodiments, where the multiple loads draw power from the power distribution grid in accordance with an embodiment.

There are numerous assets located within or along the power distribution grid, between one or more generators, such as first generator 110, and load 150. An “asset” or “electrical asset,” as used herein, refers to an item, such as one or more components of equipment, involved in generation and/or transmission of electrical power between one or more generators and one or more loads or consumers of the electrical power. Assets may include items such as transformers, generators, transmission lines, distribution lines, circuit breakers, reactors, circuits, and various other structures, for example.

If any of the assets becomes damaged or otherwise malfunctions, a portion of the power grid may become at least temporarily inoperable, partially or fully. For example, if one or more transformers becomes damaged, there is a potential for malfunction of a portion of the power distribution grid, which may result in at least a temporary partial power blackout.

Recently, PMUs 120 and Digital Fault Recorders (“DFRs”) 130 have seen a dramatic increase in installation in recent years, which may allow for non-invasive model validation by using sub-second-resolution dynamic data. For example, PMUs 120 and/or DFRs 130 may receive various signals and/or make measurements of such signals from a power grid of embodiment 100. Varying types of disturbances across locations in the grid of embodiment 100 along with a relatively large installed base of PMUs 120 may, according to some embodiments, make it possible to validate dynamic models of generators, such as first generator 110, and loads, such as load 150, relatively frequently and at and different operating conditions, for example.

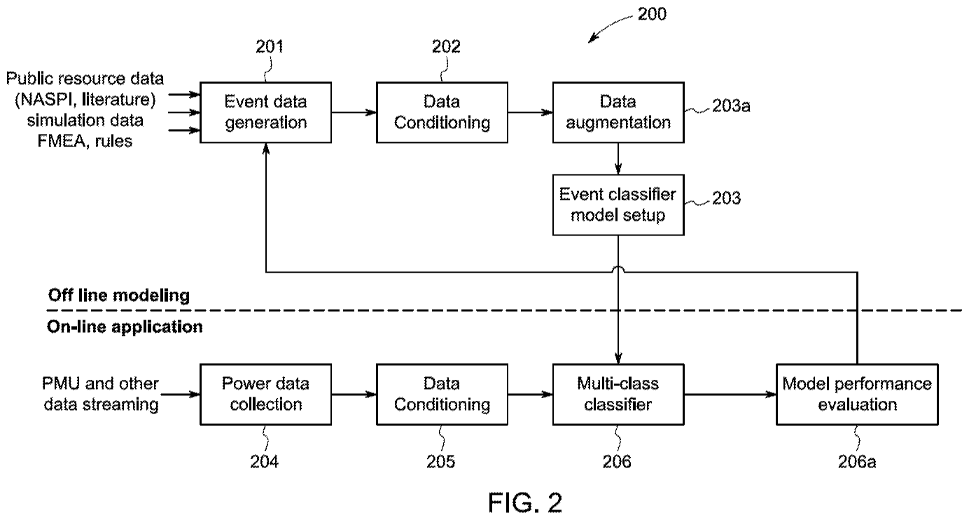

FIG. 2 is a functional block diagram of an embodiment 200 of a Extremely Fast Substation Monitoring System (EFSMS) according to an embodiment according to an embodiment. An EFSMS may determine a signature based on features from input data, may determine a residual based on a different between the signature and estimated data, and may characterize a state of an asset based on the residual, for example. As shown in embodiment 200, the EFSMS may be trained in an off-line mode and may subsequently be implemented in an on-line application. For example, an event data generation module 201 may convert images to data, convert rules to data, perform data certification and labeling, and process received labeled operational data. Event data generation module 201 may also process received public resource data such as from North American SynchroPhasor Initiative (NASPI) or other literature sources, and may processed received simulation data, rules, and Failure Modes and Effects Analysis (FMEA) data, for example. A data conditioning module 202 may perform time alignment scaling, for example, A data argumentation module 203a may perform down sampling, jittering, scaling, warping, and/or permutation. An event classifier model setup module 203 may perform event classifier model setup such as via implementation of an extreme learning machine, a support vector machine, a K nearest neighbor. The generalization capability of the built classifier can be enhanced based on cross-validation analysis, such as a Leave One Out Method

An on-line application as shown in FIG. 2 may include a power data collection module 204 to process received PMU data and/or other streaming data and may include a sliding window with a configurable window size, for example. Various received data inputs may include PMU data (30-60 Hz), SCADA data (e.g., at 2-4 seconds), weather data, DGA data, and PD monitor data, for example. PMU data may include three phase current magnitude, three phase current phase angle, three phase voltage magnitude, three phase voltage phase angle, frequency, and frequency delta, for example. SCADA data may include voltage magnitude, current magnitude, transformer (Xfmr) tap position, digital inputs (e.g., circuit breaker (CB) status), and digital outputs (e.g., trips/alarms), for example.

A data conditioning module 205 may perform time alignment for variables with different sampling rate. Also the data conditioning module 205 may perform per unit scaling to convert all data variables from their engineering scale to a dimensionless range such as [0, 1] or [−1, 1], for example.

A multi-class classifier 206 may comprise of a neural network model with its model structure and parameter trained from the output of event classifier model setup module 203. A multi-class classifier 206 process data from the output of data conditioning module 205 by using as single layer neural network, which is faster than multi-layered neural network such as deep neural network. The multi-class classifier 206 may comprise operation such as multi-time scale transformation, multi-frequency transformation, autocorrelation transformation, power spectrum transformation, multi-distance based transformation (e.g., dynamic time warping (DTW) and/or cosine) for the feature processing. Multi-class classifier module 206 may perform global classification on an inter-component basis and/or local classification for three or single phase, for example.

The output of the multi-class classifier 206 may comprise different asset health status or categories in machine learning term. These status or categories may be a full set of subset from transformer health index, instrument pre-failure, instrument drifting, loose connection, arrester pre-failure, breaker mis-operation, bad data. The output of the multi-class classifier 206 may also comprise one unclassified anomaly alarm indicating a neural network predicted output based on the feeding in input data is not significantly close to any existing classifier output categories. Therefore, it may be categorized as an “unclassified” category. Those input data (including PMU data or other streaming data together with their time stamps) and output data for the unclassified case may be stored and saved for use in the latter model performance evaluation module 206a.

A model performance evaluation module 206a may count the accumulated number of unclassified instances. Once the accumulated number of the unclassified instances exceed a predefined threshold, the system may issue a warning so that the engineer or operator is notified. The system may also provide a user interface for an operator to confirm whether the unclassified instance belongs to a particular category, also known as a particular label within the realm of machine learning. Once all the unclassified instances have been labeled by the engineer or operator, then those labeled data may be automatically sent to a database. This database may comprise an open database, e.g., which means it may keep increasing in size with data instances generated by the model performance evaluation module 206a. Once this database has reached to a certain amount or size, it may trigger off-line modeling operations or steps, e.g., by sending those newly labeled data instances into the event data generation module 201 for another cycle of off-line modeling, including modules 201, 202, 203a, and 203. Multi-class classifier 206 may be updated once the event classified model 203 has been retrained. Model performance evaluation module 206a together with the proper design of unclassified output in the classified 206 may enable a continuous learning capability for the Extremely Fast Substation Monitoring System (EFSMS).

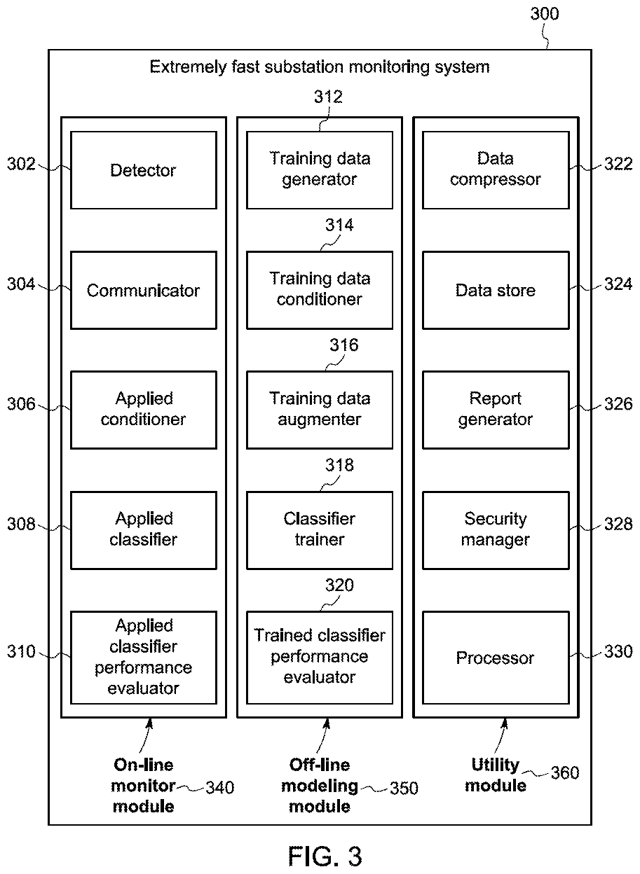

FIG. 3 is a system block diagram of an EFSMS 300 according to an embodiment. EFSMS 300 may comprise three modules, e.g., an on-line monitor module 340, an off-line modeling module 350, and a utility module 360, for example. On-line monitor module 340 may perform real time data streaming, analysis and decision-making processes at a subsecond rate, for example. Off-line modeling module 350 may perform training of a data collection, data conditioning and augmentation, classifier model setup, residual measurement, and/or evaluation, for example. Utility module 360 may perform certain common functionalities so as to facilitate operations for on-line monitor module 340 and off-line monitor module 350. On-line monitor module 340 and off-line monitor module 350 may reside in the same operating system or may reside in separate multiple virtual machines (VMs or guests) and may be instantiated at a software level on a single physical computer (e.g., a host computer), for example. A hypervisor may serve as an interface between guests and a host operating system for some or all of the functions of the guests, for example.

Detector 302 may sense, detect, and/or measure power system component conditions from data sources, such as from one or more PMUs, a frequency monitoring network (FNET), a frequency disturbance recorder, an intelligent equipment device, a digital fault recorder at a subsecond rate (1-60 ms), or from remote terminal units (RTUs), or digital control systems on the order of 1-10 seconds, for example. Such data may comprise information relating to operating voltage(s) (e.g., single phase, multi-phase), load current(s) (e.g., single phase, multi-phase), apparent power and load factor, oil temperature, oil level, hot-spot temperature, busing power factor, transformer power factor, transformer efficiency, bottom oil temperature, module temperature, gas quantity and rate (e.g., in Buchholz relay), gas-in-oil content, moisture-in-oil content, aging rate, humidity of air inside conservator, air pressure, cooling power, intake and outlet cooling equipment temperatures, differences of intake and outlet temperatures, automatic voltage regulator (AVR), digital status information, on-load tap changer position, number of switching operations, the sum of switched load current, operating conditions of pumps and fans, cooling efficiency, ambient temperature, and/or auxiliary digital inputs, to name just a few examples among many.

Communicator 304 may receive and transmit data to other functional system, via a wireline or wireless communication, in accordance with a specified communication protocol (e.g., IEEE 37.118 for PDC, IEC 870-5-101/104; Distributed Network Protocol (DNP), such as DNP-3), for example. Applied Conditioner 306 may perform time alignment for data from different sampling rate or locations with different time zone and scaling of the raw data to per unit data so that the monitoring system is applicable to different units or scales.

Applied classifier 308 may perform abnormal condition detection and localization in one shot. For example, various machine learning based classifiers may be applied, including Extreme learning machine, Support Vector Machine, and/or K Nearest Neighbor, to name just a few examples among many. Applied classifier 308 may include a built-in automatic feature extraction, transformation (time, frequency, etc.), selection and aggregation to facilitate the classifier decision making process, for example.

An applied classifier performance evaluator 310 may evaluate the performance of the applied classifier 308 based on, for example, a number of “unclassified” outputs in a certain time period, which may indicate a degree of model degradation. A model update request may be issued to off-line modeling module 350 once model degradation goes above predefined criteria (e.g., total count of unclassified output and/or operator complaints input).

A training data generator 312 may collect and select useful data samples associated with health, mis-operation, degradation, failure, and/or a pre-failure state for a substation system and/or component. Such data may be collected from simulation results based on user-specified or system and component level failure modes which may generate the above-mentioned system state, for example. A power system simulator such as Power Systems Computer Aided Design (PSCAD), Positive Sequence Load Flow (PSLF), Transient Simulation (TSAT), and/or Power System Simulation for Engineering (PSS/E) may be part of training data generator 312, for example. Training data may also come from published data from Electric Power related literature (e.g., from an NASPI report, seminar, event report, or Institute of Electrical and Electronics Engineers (IEEE) Journals). Data represented as image or rules may be converted to training data with a pre-specified format. Data from different sources may be certified based on a level of authority or reputation, or by Subject Matter Experts, for example. In an embodiment, all data may be labeled.

Training data conditioner 314 may perform time alignment for data from different sampling rates or locations with different time zones. Training data conditioner 314 may also scale raw data to per unit data so that the monitoring system is applicable to different units or scales, for example.

Training data augmenter 316 may increase a training data size feeding to a machine learning based classifier to avoid overfitting and improve a generalization capability. Data warping, slicing, jittering, scaling, down sampling, over sampling on an original data space may be used, for example. Alternatively, a time series dataset may be converted to image or symbols, and then different image transformation approaches may be performed, such as rotation, flip, color variation, and/or noise, to name just a few examples among many. Generative Adversarial Nets (GANs) may also be leveraged by training data augmenter 316, for example.

Classifier trainer 318 may split data into training, validation, and testing datasets. Classifier trainer 318 may also access a machine learning algorithm repository (e.g., in data store 324) to select a specific machine learning algorithm, such as extreme learning machine, support vector machine, K nearest neighbor, convolutional neural network, similarity learning, decision trees, linear discriminant analysis, naive Bayes, logistic regression and linear regression, random forests, and/or ensembles of classifiers, to name just a few examples among many. Such algorithms may learn/infer a function (e.g., defined by a model structure and/or parameters) which maps an input to an output based on example input-output pairs in a training and validation dataset, which may be used for mapping new data input. A model structure and parameters may be determined by different optimization algorithms guided by an optimization objective function such as empirical risk minimization or structural risk minimization, for example. As an example, cross validation may be used to determine these structural or parameter values. The trained classifier may be further evaluated by a trained classifier performance evaluation 320 before it may be deployed as the applied classifier.

Trained classifier performance evaluator 320 may evaluate different trained models (e.g., classifiers) using field data. During an evaluation, e.g., each candidate trained classifier may be operated in parallel with an applied classifier by taking the same input data and generating the predicted data. The evaluation may also be performed using historical data generated by applied classifier performance evaluator 310. Performance metrics in terms of speed, accuracy, robustness for each trained classifier may be evaluated and the best metrics may be selected as the candidate to replace the applied classifier performance evaluator 310, for example.

Data compressor 322 may compress or decompress data being transmitted to or received from another component, in accordance with a specified compression/decompression algorithm(s) such as lossless compression algorithms or lossy compression algorithms. Examples of lossless compression algorithms include Lempel-Ziv (LZ) compression algorithm, LZ-Renau (LZR) compression algorithm, Huffman coding, and DEFLATE, for example.

Examples of lossy compression algorithms include Mu-law Compander, A-law Compander, and Modulo-N code, for example. Sch algorithms may be utilized to facilitate reducing an amount of data bits being communicated thereby easing a communication load between system 300 and another component with which the system 300 is communicating, for example.

Data store 324 may store data structures, code structure(s) (e.g., modules, objects, classes, procedures) or instructions, control information, information (e.g., rules, algorithms) relating to power system, information (e.g., power condition related data, measurement data, data analysis information, sensed information, and/or power system warning indicators, etc.), security and/or authentication related information, and/or data compression related information, to name just a few examples among many. In an aspect, a processor 330 may be functionally coupled (e.g., through a memory bus) to data store 324 in order to store and retrieve information desired to operate and/or confer functionality, at least in part, to the components of the system 300 (e.g., detector 302, communicator 304, etc.).

Report generator 326 may generate reports relating to status information relating to the power system component(s), on command (e.g., from a user). Report generator 326 may also generate reports automatically in response to detected event(s), or periodically, wherein the report may be generated and provided (e.g., transmitted) to a desired destination (e.g., a destination address such as an email address of an operator, etc.). Report generator 326 may also generate alarms indicating an abnormal condition (e.g., fault, power system parameter outside of predefined threshold parameter value or range of parameter values, etc.), using a visual, audio, and/or vibrational indicator, e.g., which is detectable via other senses (e.g., touch).

Security manager 328 may secure a data access process based on authentication credentials and different levels of access rights via security and authentication algorithms and protocols, for example. Security manager 328 may also encrypt/decrypt data being stored by the system 300 and/or data transmitted to another component using a cryptographic algorithm (e.g., encryption/decryption algorithm, such as data encryption standard (DES)-type algorithms, advanced encryption standard (AES)-type algorithms, symmetric key algorithms, etc.). Security manager 328 may additionally employ anti-tamper techniques to maintain integrity of components and data, prevent or resist unauthorized access of data, and/or generate and send a tamper indicator to a desired entity in response to detecting a tamper event (e.g., an attempt to tamper with or gain unauthorized access to the system 300).

Processor 330 may operate in conjunction with other components (e.g., detector 302, communicator 304, etc.) to facilitate performing various functions of the system 300. Processor 330 may employ one or more processors, microprocessors, or controllers which may process data, and control data flow between the system 300 and other external components.

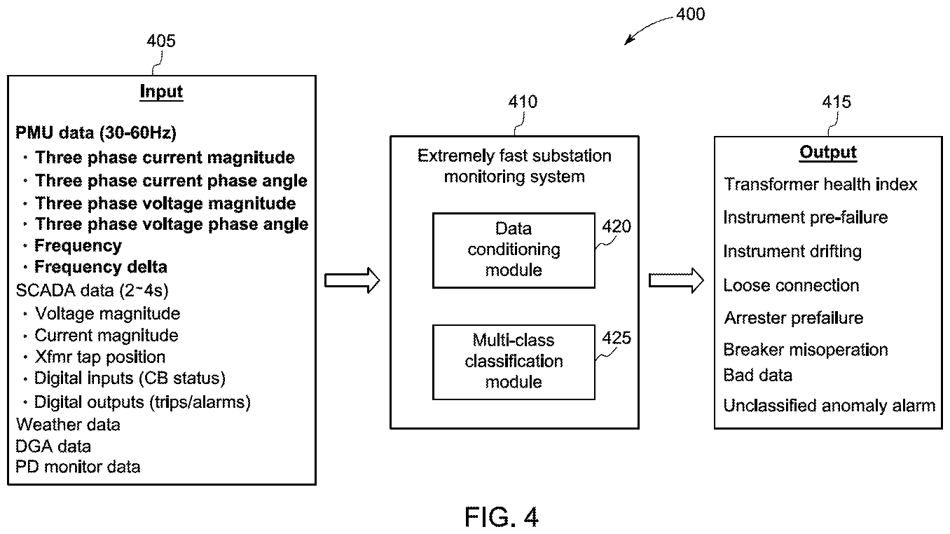

FIG. 4 illustrates an embodiment 400 a system diagram of a EFSMS 410 and corresponding inputs 405 and outputs 415 according to an embodiment. As illustrated, various inputs may include PMU data (30-60 Hz), SCADA data (e.g., at 2-4 seconds), weather data, DGA data, and PD monitor data, for example. PMU data may include three phase current magnitude, three phase current phase angle, three phase voltage magnitude, three phase voltage phase angle, frequency, and frequency delta, for example. SCADA data may include voltage magnitude, current magnitude, transformer (Xfmr) tap position, digital inputs (e.g., circuit breaker (CB) status), and digital outputs (e.g., trips/alarms), for example.

Various outputs are shown in FIG. 4, such as a transformer health index, instrument pre-failure, instrument drifting, loose connection, arrester pre-failure, breaker mis-operation, bad data, and unclassified anomaly alarm, to name just a few examples among many.

EFSMS 410 may receive the inputs 405 and generate the outputs 415. EFSMS 410 may include, e.g., a data conditioning module 420 and a multi-class classifier or classification module 425.

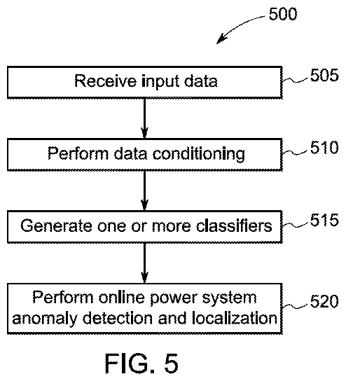

FIG. 5 illustrates an embodiment 500 of a process for performing asset monitoring of power substation asset monitoring system. Embodiments in accordance with claimed subject matter may include all of, less than, or more than blocks 505 through 520. Also, the order of blocks 505 through 520 is merely an example order. A portion of the process of embodiment 500 may be performed via an offline analysis, such as operations 505-520, and another portion of embodiment 500 may be performed via an online analysis, such as operation 520.

At operation 505, input data may be received. For example, the input data may comprise training data which may include training data from a power system simulator, acquired from an equipment failure mode data sheet and/or publicly available PMU related asset data, and/or real time classifier performance monitor selected historical data, to name just a few examples among many. In accordance with an embodiment, training data may be augmented by Down sampling, Jittering, Scaling, warping, and/or permutation (three phase), e.g., to enhance the classifier's prediction accuracy and generalization capability.

At operation 510, data conditioning may be performed on the training data. For example data conditioning may comprise time alignment for variables with different sampling rates. Operation 510 may additionally perform per unit scaling to convert all data variables from their engineering scale to a dimensionless range such as [0, 1] or [−1, 1], for example.

At operation 515, one or more classifiers may be generated based on the conditioned data. A multi-class classifier may comprise one or more neural networks, Extreme Learning Machines, k-nearest neighbors, naive Bayes, decision trees, or support vector machines, to name just a few examples among many.

For neural network, multiclass perceptrons provide a natural extension to a multi-class problem. Instead of just having one neuron in the output layer, with a binary output, one may have N binary neurons leading to a multi-class classification. In practice, the last layer of a neural network is usually a softmax function layer, which is the algebraic simplification of N logistic classifiers, normalized per class by the sum of the N−1 other logistic classifiers.

Extreme Learning Machines (ELM) comprise a special case of single hidden layer feed-forward neural networks (SLFNs) where the input weights and the hidden node biases may be chosen at random. Many variants and developments may be made to an ELM for multiclass classification.

k-nearest neighbors kNN is one considered to comprise one of the oldest non-parametric classification algorithms. To classify an unknown example, the distance from that example to every other training example may be measured. The k smallest distances may be identified, and the most represented class by these k nearest neighbors is considered to comprise the output class label.

Naive Bayes comprises a successful classifier based upon the principle of maximum a posteriori (MAP). This approach is naturally extensible to the case of having more than two classes and has been shown to perform well in spite of the underlying simplifying assumption of conditional independence.

Decision tree learning is a powerful classification technique. A tree may attempt to infer a split of the training data based on the values of the available features to produce a good generalization. The algorithm may naturally handle binary or multiclass classification problems. The leaf nodes may refer to either of the K classes concerned.

Support vector machines may be based upon the idea of maximizing the margin, e.g., maximizing the minimum distance from the separating hyperplane to the nearest example. The basic SVM may support only binary classification, but extensions have been proposed to handle the multiclass classification case as well. In these extensions, additional parameters and constraints may be added to the optimization problem to handle the separation of the different classes.

Operation 510 may utilize hierarchical classification which tackles the multi-class classification problem by dividing the output space, e.g., into a tree. Each parent node may be divided into multiple child nodes and the process may be continued until each child node represents only one class. Several methods have been proposed based on hierarchical classification.

At operation 520, an online power system anomaly detection and localization operation may be performed on input data measurements, such as data from one or more data source components comprising at least one of a power system health sensor, a heat sensor, a voltage sensor, a current sensor, a power system balance sensor, a harmonic level sensor; a power system parameter sensor, a fault sensor, a frequency monitoring network (FNET), a phasor measurement unit (PMU) FNET (PMU/FNET), a frequency disturbance recorder, an intelligent equipment device; digital fault recorder; a fault current limiter, a fault current controllers, and/or an equipment data file associated with a piece of substation equipment, to name just a few examples among many. At least a portion of the power system related data may be generated at a subsecond rate, and the data may comprise PMU or synchrophasor data. Operation 520 may be performed to detect and localize an anomaly within the data from the various components and may, e.g., identify or generate a state of a substation system and component and/or an unclassified state. At operation 520, a real time classifier may provide a diagnosis at a sub second rate. In accordance with one or more embodiments, a model update may be triggered when number of unclassified instances reaches a threshold value, for example.

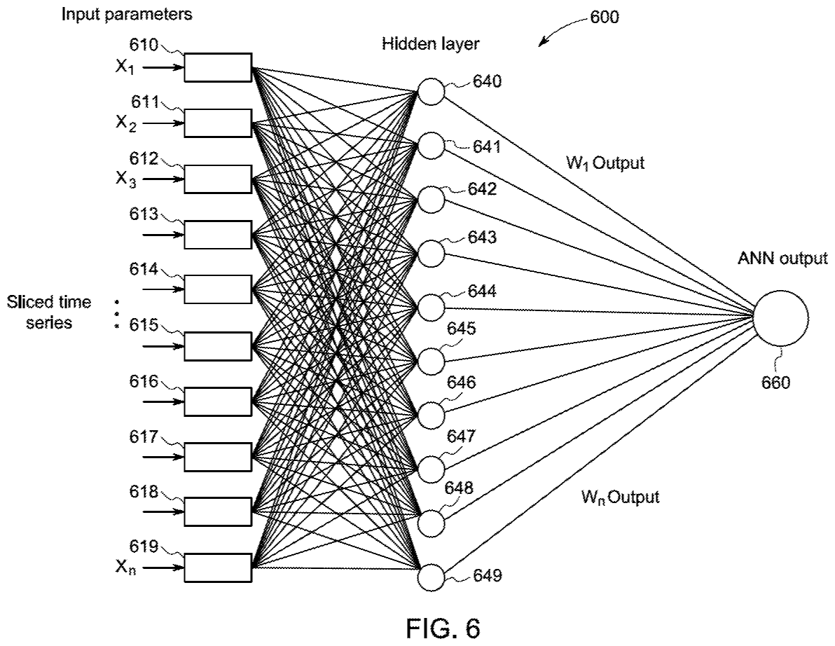

FIG. 6 illustrates an embodiment 600 of a neural network for determining a classifier for an EFSMS. For example, embodiment 600 includes various input layer nodes (e.g., listed at input parameter nodes 610-619), various hidden layer nodes (e.g., listed at hidden layer nodes 640-649), and an Artificial neural network (ANN) output node 660. Although ten input parameter nodes and ten hidden layer nodes are illustrated in embodiment 600, it should be appreciated that in some embodiments, a different number of input parameter nodes and hidden layer nodes may instead be utilized, e.g., depending on the particular application.

In one particular embodiment, a Nearest Neighbor classifier may be implemented using dynamic time warping as a similarity metric, for example. In a Nearest Neighbor classifier embodiment, each hidden layer node may store a time sequence which may comprise a representative sequence from a cluster. The cluster may represent a specific system state such as normal, transformer pre-failure, potential transformer (PT) pre-failure, voltage transformer (VT) pre-failure, arrestor pre-failure, circuit breaker mis-operation, loose connection, or instrument drifting, to name just a few examples among many.

Each hidden layer node of an Nearest Neighbor classifier may perform a dynamic time warping function as shown in Relation 1 to generate the similarity between the incoming time series to the cluster center time sequence in accordance with a particular embodiment.

$$\begin{matrix} \\ Dynamic Time \\ Warping ( DTW )\end{matrix} i ) = min \sqrt{{\sum }_{k = 1}^{K} {w}_{k}} , \qquad [ Relation 1 ]$$

In Relation 1, [symbol] ₖ may comprise a distance which corresponds to the kth element of warping path W.

Other similarity functions may be utilized in the hidden layer nodes such as Euclidean and Manhattan distance, and a cosine similarity function, to name just a few examples among many. Hidden layer nodes may utilize the same similarity function or may have multiple different similarity functions for each cluster center, for example. An output layer extending from a particular hidden layer node, such as hidden layer node 640, to ANN output node 660 may utilize a voting function to pass out a specific system state from hidden layer nodes. Alternatively, an output layer may instead utilize a linear combination method which combines similarity matrices in a linear way, and which may comprise an ensemble classifier, for example.

In another particular embodiment, a single layered neural network may be used as the classifier. An input parameter variable may comprise one or multiple time series (e.g., PMU data) with a certain length. The input parameter nodes shown in FIG. 6 each receive input parameters and may serve as a transformation layer. Such input parameter nodes may perform down sampling to generate sketches of a time series at different time scales. The input parameter nodes may also perform various filtering operations to generate multiple new time series with varying degrees of smoothness using move average at different window sizes, for example.

A hidden layer node as shown in FIG. 6 may generate a similarity between a streaming time series to a pretrained time series (or its feature or cluster center) using either distance based or feature based similarity metrics, such as is shown in the right side of FIG. 6, for example. Relations 2-6 illustrate similarity functions which may be utilized in hidden layer nodes, for example.

$$\begin{matrix}\begin{matrix}Euclidian \\ distance\end{matrix} {d}_{euc} ( x , y ) = \sqrt{{\sum }_{i = 1}^{n} {( {x}_{i} - {y}_{i} )}^{2}} . & [ Relation 2 ] \\ \begin{matrix}\begin{matrix} \\ Manhattan\end{matrix} \\ distance\end{matrix} {d}_{man} ( x , y ) = {\sum }_{i = 1}^{n} \vert ( {x}_{i} - {y}_{i} ) \vert . & [ Relation 3 ] \\ \begin{matrix}Discrete Fourier \\ Transform ( DFT )\end{matrix} X ( l ) = {\sum }_{k = 0}^{n - 1} {x}_{k} {e}^{- \frac{i 2 π}{n} lk} . & [ Relation 4 ] \\ \begin{matrix}Discrete Wavelet \\ Transform ( DWT )\end{matrix} Wave ( τ , s ) = {Σ}_{t} {x}_{t} \frac{1}{\sqrt{s}} {ψ}^{*} ( \frac{t - τ}{s} ) & [ Relation 5 ] \\ \begin{matrix}Symbolic Aggregate \\ approximation \\ ( SAX )\end{matrix} NDIST ( \hat{X} , \hat{Y} ) = \sqrt{\frac{n}{w}} \sqrt{{\sum }_{i = 1}^{w} {( dist ( {\hat{x}}_{i} , {\hat{y}}_{i} ) )}^{2}} , & [ Relation 6 ]\end{matrix}$$

An output layer may aggregate outputs of hidden layer nodes either using voting or ensemble weighting approaches, for example. The voting may select the highest votes as the classified result. Ensemble weighting may utilize a linear combination method which combines distance matrices in a linear way.

It should be noted that a connection between the input parameter nodes and hidden layer nodes may be fully or partially connected, for example. It should also be noted that the number of output nodes may be determined with integer coded each representing different meaning (normal, unclassified, malfunction, pre-failure, etc.). The number of output nodes may alternatively comprise a plurality, e.g., with each output node presenting a state (e.g., normal, unclassified, malfunction, component X pre-failure, etc.).

A shallow classifier in accordance with FIG. 6 may have faster speed during a real application. For example, if there are 178 time series with window size of 800 samples and an artificial neural network (ANN) model has 300 hidden nodes with 1 output, then it may take 0.01 s during a real time calculation for a dual core i5 CPU, for example. It may be relatively simple for a neural network in accordance with embodiment 600 to accommodate new knowledge or new clusters as additional hidden node without changing other trained weights and bias. The scalability of embodiment 600 may make this embodiment 600 well-suited for relatively small sample size learning problems while there are relatively few labeled substation events, e.g., which may simplify a “cold start” problem, for example.

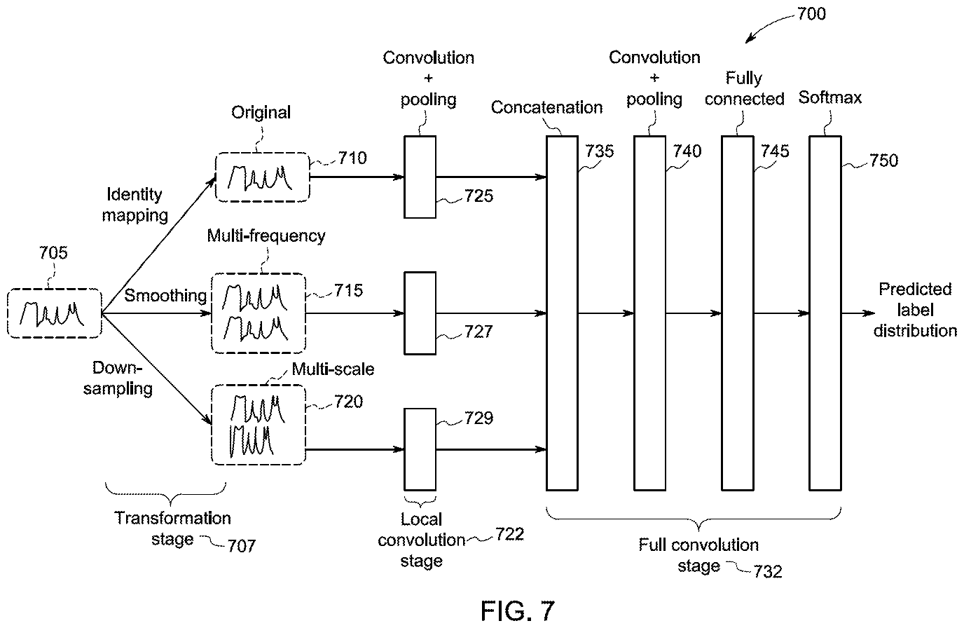

FIG. 7 illustrates an embodiment 700 of a multi-scale convolutional neural network (MCNN) framework for determining a classifier for an EFSMS. MCNN embodiment 700 include three sequential stages: a transformation 707, a local convolution stage 722, and a full convolution stage 732.

As illustrated, an input time series may be received at input box 705. A transformation stage 707 may apply various transformations on an input time series. Examples of transformations include identity mapping, down-sampling transformations in the time domain, and spectral transformations in the frequency domain, for example. Identity mapping may be applied to the input time series and provided to a first processing block 710 comprising the original time series. A smoothing operation may be applied to the input time series and provided to a second processing block 715 comprising a multi-frequency time series. A down-sampling operation may be applied to the input time series and provided to a third processing block 720 comprising a multi-scale time series. Each portion of a stage may be referred to as a branch, as it is a branch input to a convolutional neural network, for example.

In a local convolution stage 722, several convolutional layers, such as boxes 725, 727, and 729, may be utilized to extract features for each branch. In this stage, convolutions for different branches may be independent from each other. All outputs may pass through a max pooling procedure with multiple sizes.

In a full convolution stage, extracted features may be concatenated at box 735. Additional convolutional layers may be applied (e.g., with each followed by max pooling) at box 720. At box 745, fully connected operations may be performed. A softmax operation may be performed at box 750 to generate the final output. A softmax function may take as input a vector of K real numbers and may normalize it into a probability distribution consisting of K probabilities proportional to the exponentials of the input numbers. Embodiment 700 may comprise an entirely end-to-end system and all parameters may be trained jointly through back propagation.

A distinctive feature of MCNN, e.g., is that its first layer contains multiple branches that perform various transformations of the time series, including those in the frequency and time domains, for extracting features of different types and time scales. Subsequent convolutional layers may apply dot products between transformed waves and 1-D learnable filters, which may therefore comprise a general way to automatically recognize various types of features from an input. As a single convolutional layer may detect local patterns similar to shapelets, stacking multiple convolutional layers may construct more complex patterns, for example. Utilizing this network structure, autocorrelation (ACF) and power spectrum (PS) transforms may be added or otherwise applied in a transformation stage. A Teager-Kaiser energy tracking operator (TKEO) transform may additionally be added for frequency variables, symbolic transformation, and/or image embedding transformations, which may further improve classification performance, for example.

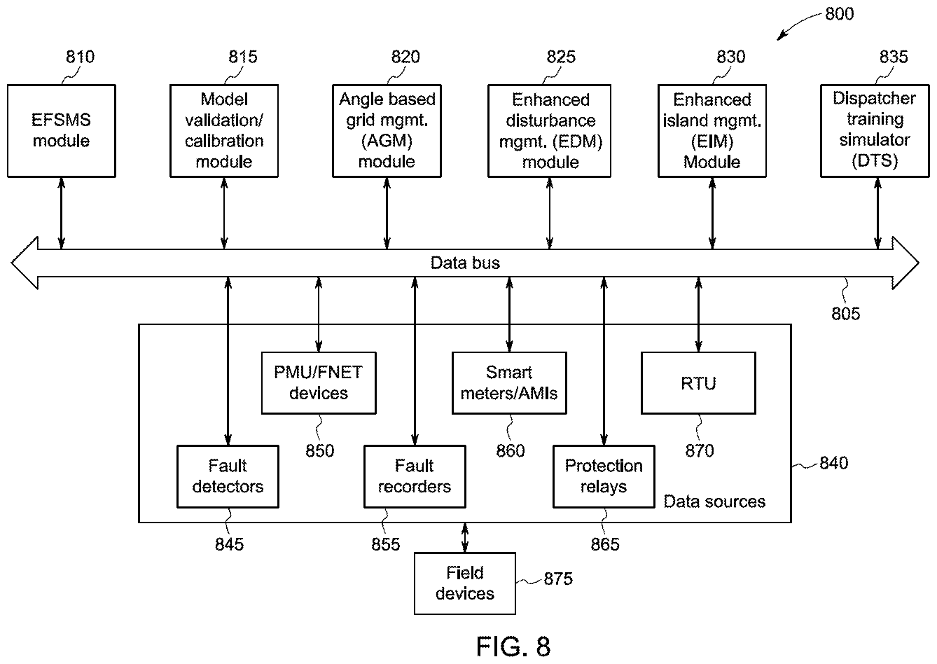

FIG. 8 illustrates an embodiment 800 of a system architecture diagram of a power management system. As shown, various components may transfer data via a data bus 805, such as EFSMS module 810, a model validation/calibration module 815, an angle-based grid management (AGM) module 820, an enhanced disturbance management (EDM) module 825, an enhanced island management (EIM) module 830, a dispatcher training simulator (DTS) module 835, and one or more data source 840. The data sources 840 may include various devices or components, such as one or more fault detectors 845, one or more PMU/Frequency monitoring Network (FNET) devices 850, one or more fault records 855, one or more smart meters/Advanced metering infrastructure (AMIs) devices 860, one or more protection relays 865, and at least one remote terminal unit (RTU) 870, for example. These devices may, e.g., generate and provide data to the EFSMS module 810 at a subsecond rate, to facilitate real time or at least near real time identification of the health status of the power asset and diagnosis. One of more field devices 875 may also provide measurements to data sources 840, for example.

In one particular aspect, the information exchange among the EFSMS module 810, model validation/calibration module 815, angle-based grid management (AGM) module 820, an enhanced disturbance management (EDM) module 825, an enhanced island management (EIM) module 830 may further enhance each other. The EFSMS module 810 may detect and/or identify an abnormal condition relating to operation or equipment condition, and may trigger (e.g., dynamically or automatically) real-time alarming to the WAMS/EMS (and/or 815, 820,825, 830) in case of an abnormal condition being detected, so that the grid operator may be immediately informed of potential issues with the substation equipment. The approach is to provide an early warning signal, which may avoid a potential harmful situation such as sudden failure of a piece of substation equipment with immediate negative impact on the power grid operation, such as, for example, an emergency power outage. In an aspect, the grid operator may perform a desired corrective action to rectify, prevent, alleviate, and/or minimize a potentially harmful situation, as detected by the EFSMS module 810. For instance, the early detection of the potential harmful situation relating to the substation and generation of the early warning signal by the EFSMS module 810 may leave time for the grid operator to identify an alternate operation scheme (e.g., transformer de-ration and load transfer, for instance), where the alternate operation scheme may be implemented by the grid operator to eliminate, prevent, or minimize a negative impact on the power grid operation. In another aspect, the health status generated by the EFSMS module 810 together with the result generated by model validation/calibration module 815, AGM module 820, EDM module 825, and/or EIM module 830 may provide a complete view and critical contextual information for the grid operator to make real time decisions. For example, a disturbance detection results from EDM module 825 together with the early warning result from EFSMS module 810 may help the operator quickly identify the fault location. As another example, the results from EFSMS module 810, model validation/calibration module 815, AGM module 820, EDM module 825, and/or EIM module 830 may feed in to DTS 835 to enrich the training scenarios in the dispatcher training simulator.

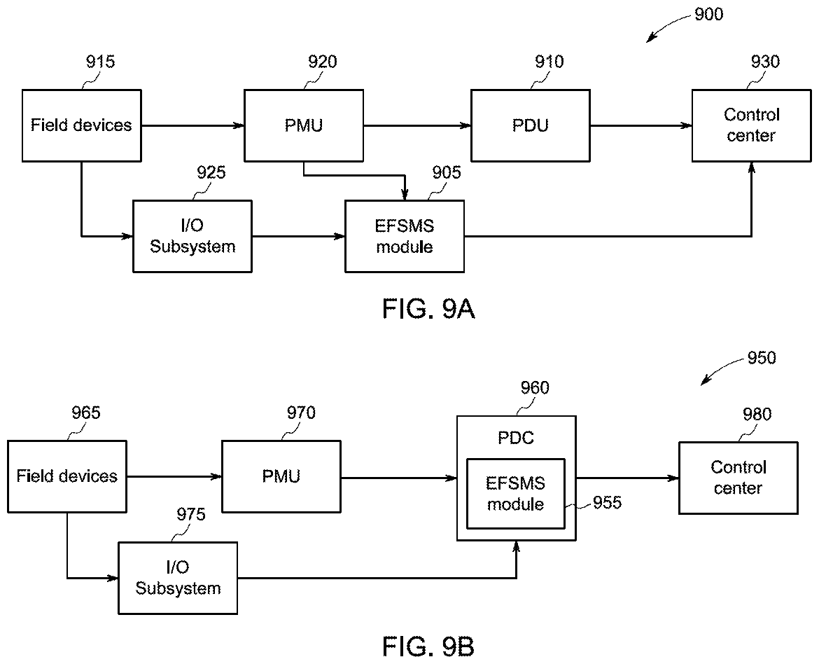

FIG. 9A illustrates a system diagram of an embodiment 900 in which an EFSMS module 905 is disposed separate from a phasor data concentrator (PDC) 910. Embodiment 900 may also include one or more field devices 915, at least one PMU 920, an Input/Output (I/O) subsystem 925, and a control center 930. In embodiment 900, EFSMS module 905 may be installed geographically or physically close to each PMU 920 and may collect streaming data from each PMU 920 or even point-on-wave data which may have include higher fidelity data. One particular advantage of an arrangement in accordance with embodiment 900 may be in terms of a real time response.

FIG. 9B illustrates a system diagram of an embodiment 950 in which an EFSMS module 955 is integrated with a PDC 960. Embodiment 950 may also include one or more field devices 965, at least one PMU 970, an I/O subsystem 975, and a control center 980. PDC 960 may collect input data from multiple PMUs 900. One particular advantage of an arrangement in accordance with embodiment 950 is that a condition monitoring module, such as via control center 980, may oversee global features from multiple PMUs 970 either in one or multiple substations, without losing much data streaming latency, for example.

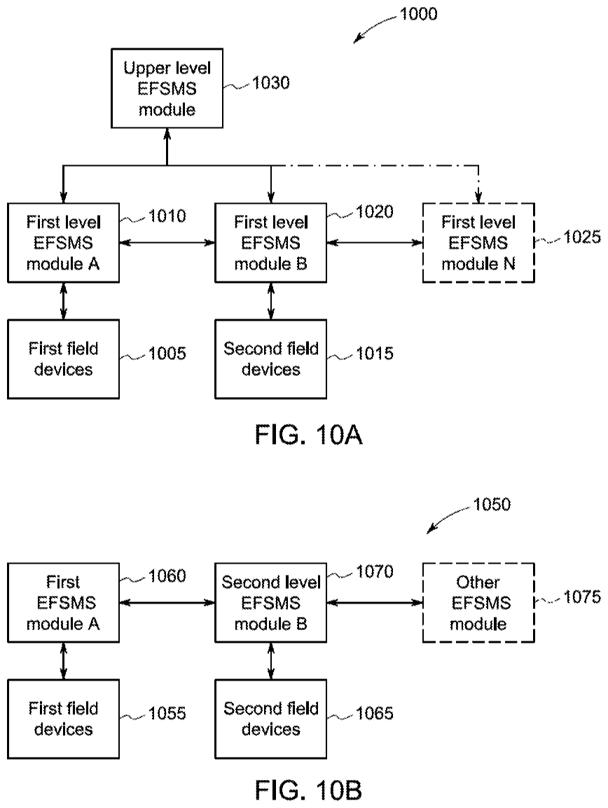

FIG. 10A illustrates a system diagram of an embodiment 1000 for a hierarchical configuration of an EFSMS. As illustrated, first field devices 1005 may provide certain data and/or measurements to first level EFSMS module A 1010. Similarly, second field devices 1015 may provide certain data and/or measurements to first level EFSMS module B 1020. First level EFSMS A 1010 may communicate with first level EFSMS module B 1020 as well as with first level EFSMS module N 1025 and upper level EFSMS module 1030.

FIG. 10B illustrates a system diagram of an embodiment 1050 for a modular and decentralized configuration of an EFSMS. As illustrated, first field devices 1055 may provide certain data and/or measurements to first level EFSMS module 1060. Similarly, second field devices 1065 may provide certain data and/or measurements to second EFMS module 1070. Second level EFSMS 1070 may communicate with first level EFSMS module 1060 as well as with one or more other EFMS modules 1075, for example.

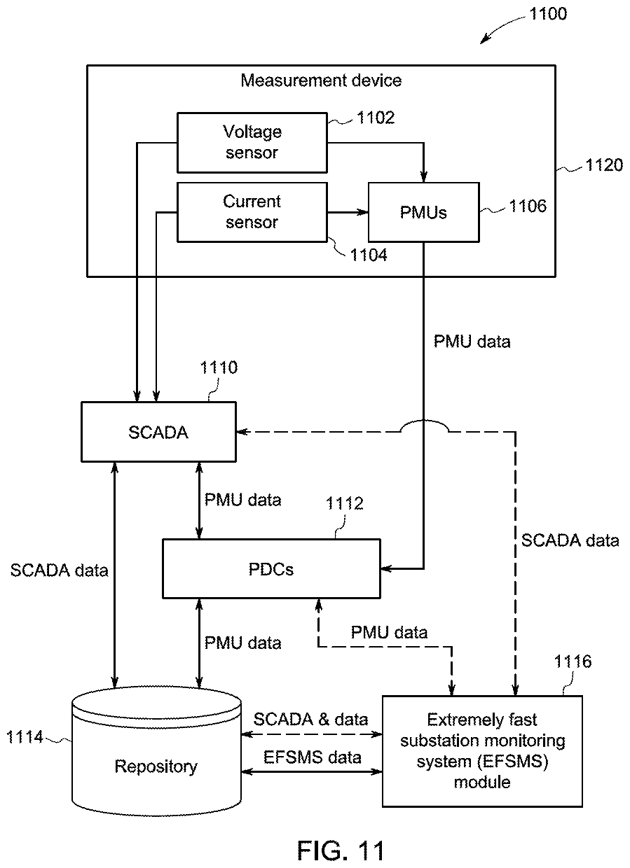

FIG. 11 illustrates a power grid system 1100 including an Extremely Fast Substation Monitoring System (EFSMS) module 1116 in accordance with an example embodiment. For example, a server may implement EFSMS module 1116. In this example, the EFSMS module 1116 may monitor the health of one or more assets of a power grid system and/or of the grid itself. In some embodiments, the EFSMS module 1116 may also store and display asset health history for one or more assets and/or of the grid itself and a variety of other statistical information related to disturbances and events, including on a graphical user interface, or in a generated report, for example.

A measurement device 1120 shown in FIG. 11 may obtain, monitor or facilitate the determination of electrical characteristics associated with the power grid system (e.g., the electrical power system), which may comprise, for example, power flows, voltage, current, harmonic distortion, frequency, real and reactive power, power factor, fault current, and phase angles. Measurement device 1120 may also be associated with a protection relay, a Global Positioning System (GPS), a Phasor Data Concentrator (PDC), communication capabilities, or other functionalities.

Measurement device 1120 may provide real-time measurements of electrical characteristics or electrical parameters associated with the power grid system (e.g., the electrical power system). The measurement device 1120 may, for example, repeatedly obtain measurements from the power grid system which may be used by the EFSMS module 1116. The data generated or obtained by the measurement device 1120 may comprise coded data (e.g., encoded data) associated with the power grid system that may input (or be fed into) a traditional SCADA system. Measurement device 1120 may also comprise one or more PMUs 1106 which may repeatedly obtain subs-second measurements (e.g., 30 times per second). Here, the PMU data may be fed into, or input into, various applications (e.g., Wide Area Monitoring System (WAMS) and WAMS-related applications) that may utilize the more dynamic PMU data (explained further below).

In the example embodiment illustrated in FIG. 11, measurement device 1120 may include a voltage sensor 1102 and a current sensor 1104 that feed data typically via other components, to, for example, a SCADA component 1110. Voltage and current magnitudes may be measured and reported to a system operator every few seconds by the SCADA component 1110. SCADA component 1110 may provide functions such as data acquisition, control of power plants, and alarm display. SCADA component 1110 may also allow operators at a central control center to perform or facilitate management of energy flow in the power grid system. For example, operators may use a SCADA component (e.g., using a computer such as a laptop or desktop) to facilitate performance of certain tasks such opening or closing circuit breakers, or other switching operations which might divert the flow of electricity.

In some examples, the SCADA component 1110 may receive measurement data from Remote Terminal Units (RTUs) connected to sensors in the power grid system, Programmable Logic Controllers (PLCs) connected to sensors in the power grid system, or a communication system (e.g., a telemetry system) associated with the power grid system. PLCs and RTUs may be installed at power plants, substations, and the intersections of transmission and distribution lines, and may be connected to various sensors, including the voltage sensor 1102 and the current sensor 1104. The PLCs and RTUs may receive data from various voltage and current sensors to which they are connected. The PLCs and RTUs may convert the measured information to digital form for transmission of the data to the SCADA component 1110. In example embodiments, the SCADA component 1110 may also comprise a central host server or servers called master terminal units (MTUs), sometimes also referred to as a SCADA center. The MTU may also send signals to PLCs and RTUs to control equipment through actuators and switchboxes. In addition, the MTU may perform controlling, alarming, and networking with other nodes, etc. Thus, the SCADA component 1110 may monitor the PLCs and RTUs and may send information or alarms back to operators over telecommunications channels.

The SCADA component 1110 may also be associated with a system for monitoring or controlling devices in the power grid system, such as an EFSMS system. An EFSMS system may comprise one or more systems of computer-aided tools used by operators of the electric power grid systems to monitor and characterize the health of one or more assets of a power grid system and/or of the grid itself. SCADA component 1110 may be operable to send data (e.g., SCADA data) to a repository 1114, which may in turn provide the data to the EFSMS module 1116. Other systems with which the EFSMS module 1116 may be associated may comprise a situational awareness system for the power grid system, a visualization system for the power grid system, a monitoring system for the power grid system or a stability assessment system for the power grid system, for example.

SCADA component 1110 may generate or provide SCADA data (e.g., SCADA data shown in FIG. 11) comprising, for example, real-time information (e.g., real-time information associated with the devices in the power grid system) or sensor information (e.g., sensor information associated with the devices in the power grid system) that may be used by the EFSMS module 1116. The SCADA data may be stored, for example, in a repository 1114 (described further below). In example embodiments, data determined or generated by the SCADA component 1110 may be employed to facilitate generation of topology data (topology data is further described below) that may be employed by the EFSMS module 1116 to monitor asset health.

The employment of current sensor 1104 and voltage sensor 1102 may allow for a fast response. Traditionally, the SCADA component 1110 monitors power flow through lines, transformers, and other components relies on the taking of measurements every two to six seconds but cannot be used to observe dynamic characteristics of the power system because of its slow sampling rate (e.g., cannot detect the details of transient phenomena that occur on timescales of milliseconds (one 60 Hz cycle is 16 milliseconds). Additionally, although SCADA technology enables some coordination of transmission among utilities, the process may be slow, especially during emergencies, with much of the response based on telephone calls between human operators at the utility control centers. Furthermore, most PLCs and RTUs were developed before industry-wide standards for interoperability were established, and as such, neighboring utilities often use incompatible control protocols.

The measurement device 1120 may also include one or more PMUs 1106. A PMU 1106 may comprise a standalone device or may be integrated into another piece of equipment such as a protective relay. PMUs 1106 may be employed at substations and may provide input into one or more software tools (e.g., WAMS, SCADA, EMS, and other applications). A PMU 1106 may use voltage and current sensors (e.g., voltage sensors 1102, current sensors 1104) that may measure voltages and currents at principal intersecting locations (e.g., substations) on a power grid using a common time source for synchronization and may output accurately time-stamped voltage and current phasors. The resulting measurement is often referred to as a synchrophasor (although the term “synchrophasor” refers to the synchronized phasor measurements taken by the PMUs 1106, some have also used the term to describe the device itself). Because these phasors are truly synchronized, synchronized comparison of two quantities is possible in real time, and this time synchronization allows synchronized real-time measurements of multiple remote measurement points on the grid.

In addition to synchronously measuring voltages and currents, phase voltages and currents, frequency, frequency rate-of-change, circuit breaker status, switch status, etc., the high sampling rates (e.g., 30 times a second) provides “sub-second” resolution in contrast with SCADA-based measurements. These comparisons may be used to assess system conditions such as: frequency changes, power in megawatts (MW), reactive power in mega volt ampere reactive (MVARs), voltage in kilovolts (KV), etc. As such, PMU measurements may provide improved visibility into dynamic grid conditions and/or of asset health and may allow for real-time wide area monitoring of power system and/or asset health dynamics. Further, synchrophasors account for the actual frequency of the power delivery system at the time of measurement. These measurements are important in alternating current (AC) power systems, as power flows from a higher to a lower voltage phase angle, and the difference between the two relates to power flow. Large phase angle differences between two distant PMUs may indicate the relative stress across the grid, even if the PMUs are not directly connected to each other by a single transmission line. This phase angle difference may be used to identify power grid instability, and a PMU may be used to generate an angle disturbance alarm (e.g., angle difference alarm) when it detects a phase angle difference.

Examples of disturbances that might cause the generation of an angle disturbance alarm may comprise, for example, a line out or line in disturbance (e.g., a line out disturbance in which a line that was in service has now gone out of service, or in the case of a line in disturbance, in which case a line that was out of service has been brought back into service). PMUs 1106 may also be used to measure and detect frequency differences, resulting in frequency alarms being generated. As an example, unit out and unit in disturbances may result in the generation of a frequency alarm (e.g., a generating unit was in service, but might have gone out of service, or a unit that was out of service has come back in to service—both may cause frequency disturbances in the system that may result in the generation of a frequency alarm.). Still yet, PMUs 1106 may also be used to detect oscillation disturbances (e.g., oscillation in the voltage, frequency, real power—any kind of oscillation), which may result in the generation of an alarm (e.g., oscillation alarm). Several other types of alarms may be generated based on PMU data from PMU based measurements. Although the disturbances mentioned (e.g., line in/out, unit in/out, load in/out) may result in angle or frequency disturbance alarms, an angle or frequency disturbance alarm might not necessarily mean that a particular type of disturbance occurred, only that it is indicative of that type of disturbance. For example, if a frequency disturbance alarm is detected, it might not necessarily be a unit in or unit out disturbance but may be a load in or load out disturbance. The measurement requirements and compliance tests for a PMU 1106 have been standardized by the Institute of Electrical and Electronics Engineers (IEEE), namely IEEE Standard C37.118.

In the example of FIG. 11, one or more Phasor Data Concentrators (PDCs) 1112 are shown, which may comprise local PDCs at a substation. Here, PDCs 1112 may be used to receive and time-synchronized PMU data from multiple PMUs 1106 to produce a real-time, time-aligned output data stream. A PDC may exchange phasor data with PDCs at other locations. Multiple PDCs may also feed phasor data to a central PDC, which may be located at a control center. Through the use of multiple PDCs, multiple layers of concentration may be implemented within an individual synchrophasor data system. The PMU data collected by the PDC 1112 may feed into other systems, for example, a central PDC, corporate PDC, regional PDC, the SCADA component 1110 (optionally indicated by a dashed connector), energy management system (EMS), synchrophasor applications software systems, a WAMS, the EFSMS module 1116, or some other control center software system. With the very high sampling rates (typically 10 to 60 times a seconds) and the large number of PMU installations at the substations that are streaming data in real time, most phasor acquisition systems comprising PDCs are handling large amounts of data. As a reference, the central PDC at Tennessee Valley Authority (TVA), is currently responsible for concentrating the data from over 90 PMUs and handles over 31 gigabytes (GBs) of data per day.

In this example, the measurement device 1120, the SCADA component 1110, and PDCs/Central PDCs 1112, may provide data (e.g., real-time data associated with devices, meters, sensors or other equipment in the power grid system) (including SCADA data and topology data), that may be used by the EFSMS module 1116 for asset health monitoring. Both SCADA data and PMU data may be stored in one or more repositories 1114. In some example embodiments, the SCADA data and PMU data may be stored into the repository 1114 by the SCADA component 1110, or by the PDC 1112. In other embodiments, the EFSMS module 1116 may have one or more components or modules that are operable to receive SCADA data and PMU data and store the data into the repository 1114 (indicated by dashed lines). The repository 1114 may comprise a local repository, or a networked repository. The data on the repository 1114 may be accessed by SCADA component 1110, the PDCs 1112, other systems (not shown), and optionally by example embodiments of the EFSMS module 1116. In example embodiments, the EFSMS module 1116 may be operable to send instructions to one or more other systems (e.g., SCADA component 1110, PDCs 1112) to retrieve data stored on the repository 1114 and provide it to the EFSMS module 1116. In other embodiments, the EFSMS module 1116 may facilitate retrieval of the data stored in repository 1114, directly.

In example embodiments, the data stored in the repository 1114 may be associated SCADA data and PMU data. The data may be indicative of measurements by measurement device 1120 that are repeatedly obtained from a power grid system. In example embodiments, the data in repository 1114 may comprise PMU/SCADA-based equipment data, such as, for example, data associated with a particular unit, line, transformer, or load within a power grid system (e.g., power grid system 1100). The data may comprise voltage measurements, current measurements, frequency measurements, phasor data (e.g., voltage and current phasors), etc. The data may be location-tagged. For example, it may comprise a station identification of a particular station in which a power delivery device being measured is located (e.g., “CANADA8”). The data may comprise a particular node number designated for a location. The data may comprise the identity of the measure equipment (e.g., the identification number of a circuit breaker associated with an equipment). The data may also be time-tagged, indicating the time at which the data was measured by a measurement device. The PMU/SCADA-based equipment data may also contain, for example, information regarding a particular measurement device (e.g., a PMU ID identifying the PMU from which measurements were taken).

In example embodiments, the data stored in repository 1114 may comprise not only collected and measured data from various measurement devices, the data may also comprise data derived from that collected and measured data. The data derived may comprise topology data (e.g., PMU/SCADA-based topology data), event data, and event analysis data, and EFSMS data (data generated by EFSMS module 1116).

In example embodiments, the repository 1114 may contain topology data (e.g., PMU/SCADA-based topology data) indicative of a topology for the power grid system 1100. The topology of a power grid system may relate to the interconnections among power system components, such as generators, transformers, busbars, transmission lines, and loads. This topology may be obtained by determining the status of the switching components responsible for maintaining the connectivity status within the network. The switching components may be circuit breakers that are used to connect (or disconnect) any power system component (e.g., unit, line, transformer, etc.) to or from the rest of the power system network. Typical ways of determining topology may be by monitoring of the circuit breaker status, which may be done using measurement devices and components associated with those devices (e.g., RTUs, SCADA, PMUs). It may be determined as to which equipment has gone out of service, and actually, which circuit breaker has been opened or closed because of that equipment going out of service.

The topology data may be indicative of an arrangement (e.g., structural topology, such as radial, tree, etc.) or a power status of devices in the power grid system. Connectivity information or switching operation information originating from one or more measurement devices may be used to generate the topology data. The topology data may be based on a location of devices in the power grid system, a connection status of devices in the power grid system or a connectivity state of devices in the power grid system (e.g., devices that receive or process power distributed in throughout the power grid system, such as transformers and breakers). For example, the topology data may indicate where devices are located, and which devices in the power grid system are connected to other devices in the power grid system (e.g., where devices in the power grid system are connected, etc.) or which devices in the power grid system are associated with a powered grid connection. The topology data may further comprise the connection status of devices (e.g., a transformer, etc.) that facilitate power delivery in the power grid system, and the statuses for switching operations associated with devices in the power grid system (e.g., an operation to interrupt, energize or de-energize or connect or disconnect) a portion of the power grid system by connecting or disconnecting one or more devices in the power grid system (e.g., open or close one or more switches associated with a device in the power grid system, connect or disconnect one or more transmission lines associated with a device in the power grid system etc.). Furthermore, the topology data may provide connectivity states of the devices in the power grid system (e.g., based on connection points, based on busses, etc.).

In example embodiments, the repository 1114 may contain a variety of event and event analysis data, which may be derived based on PMU data, and in some embodiments, other data as well (e.g., SCADA data, other measurement data, etc.). The data may comprise information regarding the health of one or more assets of the power grid system and/or of the grid itself. The various data stored in the repository 1114, including equipment data, topology data, event data, event analysis data, EFSMS data, and other data, may be inputs into the various functionalities and operations that may be performed by the EFSMS module 1116.

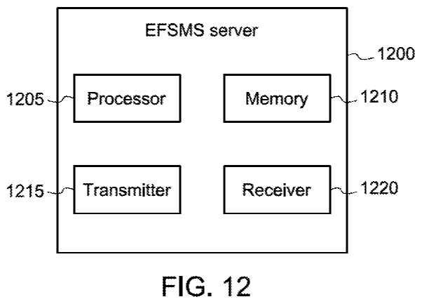

FIG. 12 illustrates an EFSMS server 1200 according to an embodiment. For example, EFSMS server 900 may include a processor 1205, a memory 1210, a transmitter 1215, and a receiver 1220, to name just a few example components among many possibilities. For example, receiver 1220 may receive data such as PMU data, SCADA data, weather data, and other information such as DGA data and/or PD monitor data, as discussed above with respect to FIG. 4. Processor 1205 may, for example, execute program code or instructions stored in memory 1210 to process signals received by receiver 1220 to perform one or more data conditioning operations on input data and may also generate a multi-class classifier based on the conditioned data. Processor 1220 may also classify power system related data from field devices to generate state of substation system, and component, and an unclassified state, for example. Transmitter 1215 may transmit one or more messages, such as one or more alerts, based on calculations by processor 1205. For example, if processor 1205 identifies an anomaly such as an asset or sensor which has failed or is about to fail, an alert, such as a message, may be transmitted to computing device tasked with managing operation of that asset or sensor.

As will be appreciated based on the foregoing specification, one or more aspects of the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof

What is claimed is:

1. A method for monitoring a power substation asset, the method comprising:
during an offline analysis mode, acquiring training data, processing the training data, and generating one or more classifiers for an online anomaly detection and localization mode;
during the online anomaly detection and localization mode, receiving power system related data from field devices, generating a state of a substation system and of the power substation asset component and an unclassified state of one or instances based on the one or more classifiers; and
generating an alert to indicate the state of the substation system and of the power substation asset.

2. The method of claim 1, further comprising initiating an update to a model comprising the one or more classifiers in response to a number of the unclassified instances reaching a threshold value.

3. The method of claim 1, wherein at least a portion of the power system related data comprises Phasor Measurement Unit (PMU) data generated at a subsecond rate.

4. The method of claim 1, wherein the training data comprises data from a power system simulator, a transformation from an equipment failure mode data sheet and available PMU related asset data.

5. The method of claim 1, further comprising modifying the training data to enhance the classifier's prediction accuracy and/or generalization capability, wherein the modification is based on Down sampling, Jittering, Scaling, warping, and/or permutation (three phase).

6. The method of claim 1, wherein the online anomaly detection and localization mode is to provide a diagnosis result based on the power system related data at a subsecond rate.

7. The method of claim 1, wherein the state of the power asset comprises at least one of: transformer health index, instrument pre-failure, instrument drifting, loose connection, arrester pre-failure, breaker mis-operation, bad data, or unclassified state.

8. The method of claim 1, wherein the online anomaly detection and localization mode utilizes a classifier comprising at least one of: neural networks, Extreme Learning Machines, k-nearest neighbors, naive Bayes, decision trees, support vector machines, 1 Nearest Neighbor enhanced by dynamic time warping, or convolutional neural networks.

9. The method of claim 3, wherein the power system related data further comprises data from at least one of a power system health sensor, a heat sensor, a voltage sensor, a current sensor, a power system balance sensor, a harmonic level sensor, a power system parameter sensor, a fault sensor, a frequency monitoring network (FNET), a frequency disturbance recorder, an intelligent equipment device, digital fault recorder, a fault current limiter, a fault current controllers, and/or an equipment data file associated with the power substation asset component.

10. A system, comprising:
a receiver to receive power system related data from field devices and training data;
a processor to:
during an offline analysis mode, generate one or more classifiers for an online anomaly detection and localization mode in response to processing the training data;
during the online anomaly detection and localization mode, generate a state of a substation system and of a power substation asset component and an unclassified state of one or instances based on the one or more classifiers; and
generate an alert to indicate the state of the substation system and of the power substation asset.

11. The system of claim 10, wherein the processor is to further initiate an update to a model comprising the one or more classifiers in response to a number of the unclassified instances reaching a threshold value.

12. The system of claim 10, wherein at least a portion of the power system related data comprises Phasor Measurement Unit (PMU) data generated at a subsecond rate.

13. The system of claim 10, wherein the training data comprises data from a power system simulator, a transformation from an equipment failure mode data sheet and available PMU related asset data.

14. The system of claim 10, wherein the processor is to further modify the training data training data to enhance the classifier's prediction accuracy and/or generalization capability, wherein the modification is based on Down sampling, Jittering, Scaling, warping, and/or permutation (three phase).

15. The system of claim 10, wherein the online anomaly detection and localization mode is to provide a diagnosis result based on the power system related data at a subsecond rate.

16. The system of claim 10, wherein state of the power asset comprises at least one of: transformer health index, instrument pre-failure, instrument drifting, loose connection, arrester pre-failure, breaker mis-operation, bad data, or unclassified state.

17. The system of claim 12, wherein the power system related data further comprises data from at least one of a power system health sensor, a heat sensor, a voltage sensor, a current sensor, a power system balance sensor, a harmonic level sensor, a power system parameter sensor, a fault sensor, a frequency monitoring network (FNET), a frequency disturbance recorder, an intelligent equipment device, digital fault recorder, a fault current limiter, a fault current controllers, and/or an equipment data file associated with the power substation asset component.

18. An article, comprising:
a non-transitory storage medium comprising machine-readable instructions executable by one or more processors to:
process power system related data received from field devices and training data;
during an offline analysis mode, generate one or more classifiers for an online anomaly detection and localization mode in response to processing the training data;
during the online anomaly detection and localization mode, generate a state of a substation system and of a power substation asset component and an unclassified state of one or instances based on the one or more classifiers; and
generate an alert to indicate the state of the substation system and of the power substation asset.

19. The article of claim 18, wherein the machine-readable instructions are further executable by the one or more processors to initiate an update to a model comprising the one or more classifiers in response to a number of the unclassified instances reaching a threshold value.

20. The article of claim 18, wherein at least a portion of the power system related data comprises Phasor Measurement Unit (PMU) data generated at a subsecond rate.
